(19) United States
(12) Patent Application Publication
(10) Pub. No.: US 2007/0059640 A1
(43) Pub. Date: Mar. 15, 2007

(54) PROCESSING METHOD OF SUBSTRATE AND PROCESSING APPARATUS OF SUBSTRATE

(76) Inventor: Masakazu Sanada, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/531,538

(22) Filed: Sep. 13, 2006

(30) Foreign Application Priority Data
Sep. 15, 2005 (JP) 2005-267829
Sep. 15, 2005 (JP) 2005-267830

(51) Int. Cl. G03C 1/00

(52) U.S. Cl. 430/270.1

(57) ABSTRACT

A processing method of a substrate is capable of improving wettability on a surface of a resist film with respect to a developer without adverse effect on processing size of resist pattern, or without damage on the resist film. In the processing method it is also unnecessary to make separate collection of waste liquid. Before a developer is fed from a developer discharge nozzle 30 onto a resist film having been exposed that is formed on the surface of a substrate W to make processing of the resist film, a solution containing a surface-active agent is fed from a solution discharge nozzle 34 onto the resist film, and subsequently pure water is fed onto the resist film on which the solution containing a surface-active agent has been fed to make prewetting.

### BACKGROUND OF THE INVENTION

1. Field of the Invention

The present invention relates to a processing method of a substrate, in which a developer is fed onto a photo-resist film after having been exposed, the photo-resist film being formed on the surface of the substrate such as semiconductor wafer, liquid crystal display glass substrate, photo-mask glass substrate, and optical disk substrate to make processing. The invention also relates to a processing apparatus of a substrate.

2. Description of the Related Art

It is a recent trend in the manufacturing process of semiconductor devices that circuits are further integrated owing to size reduction of pattern dimensions. For example, in the exposure and development processes, as a typical means for shrinking the size of processing of a resist pattern that is formed on a substrate, it has been known that an improved resolution is achieved with the use of shorter wavelength of light beams from a source of light for exposure. That is, technology has being progressed from the conventional use of near ultraviolet rays (wavelength: 400 nm to 300 nm) to the use of KrF excimer laser (wavelength: 248 nm), from the use of KrF excimer laser to ArF excimer laser (wavelength: 193 nm), and further from the use of ArF excimer laser to the use of shorter-wavelength radiation such as far ultraviolet rays, X-rays, and electron beam. Thus, a variety of lithography processes using these exposure light sources have been proposed, and are being put into practical use.

Meanwhile, with size reduction of pattern dimensions in the manufacturing process of semiconductor devices, an aspect ratio of a resist pattern comes to be higher. As a result, a problem exists in that a resist pattern is collapsed in the development process. As means for overcoming this problem, for example, as proposed in the Japanese Patent Publication (unexamined) No. 106226/1995, the following method is proposed. According to this proposed method, in the rinse process to be done after the development process, after water is discharged onto a substrate to wash out a developer or eluted compositions of a resist, a liquid of low surface tension (for example, a liquid mixture of propyl alcohol and water) is discharged onto the substrate to substitute water on the substrate with a low-surface tension liquid, and thereafter the substrate is dried.

Additionally, the resist that meets the requirements of shorter wavelength of exposure light beam is extremely high in water repellency. Therefore, in the processing after the exposure to light, when a developer is heaped on the resist film, for example, in slit scan system, a liquid film of uniform thickness as desired is difficult to be formed, and thus a large amount of developer will be consumed in order to form a suitable developer film (puddle). Furthermore, in case of higher water repellency of a resist, the developer film itself will be hard to form.

As the method to overcome such problems, a treatment referred to as prewetting is employed. In this treatment, pure water is fed onto a resist film to cause the surface state of the resist film to be hydrophilic before the developer is heaped. By this treatment, wettability on the surface of the resist film with respect to the developer is improved, and thus a developer film of uniform thickness is formed on a resist film on the surface of the substrate, enabling to reduce the consumption of the developer. However, when water repellency of a resist comes to be still higher, besides the developer, even the pre-wet liquid (pure water) is hard to uniformly cover the surface of a resist film, and to uniformly cover the surface of the resist film with pure water, a large amount of pure water will be consumed. Moreover, in case of still higher water repellency of a resist, it comes to be impossible to make prewetting itself.

In addition, for example, as disclosed in the Japanese Patent Publication (unexamined) No. 106581/1997, the following method has been proposed. In this method, before the development after pattern exposure, instead of making prewetting or together with prewetting, hydrophilizing of surface of a resist film is made using hydrophilizing treatments such as tetramethylammonium hydroxide (TMAH), isopropyl alcohol (IPA), and diethylethanolamine, whereby wettability on the surface of the resist film with respect to the developer is improved.

However, TMAH is quite a processing liquid itself. Due to that TMAH is fed onto the surface of the resist film before the development, there arises a high likelihood of adversely affecting processing size of resist pattern. Further, since IPA or diethylethanolamine is an organic solvent, there is a risk of giving any damage on a resist film itself. Moreover, in the case of using IPA or diethylethanolamine, since it is necessary to make separate collection thereof from an aqueous solution waste liquid, a problem exists in that construction of a processing apparatus becomes complicated.

In addition, as described above, with respect to a problem of destruction of a resist pattern that occurs due to size reduction of pattern dimensions, and a problem in that a developer film is hard to form in relation to technical progress for size reduction of pattern dimensions, suitable rinses and pre-wet liquids have been conventionally proposed respectively. Consequently, in the processing apparatus, a discharge line of rinse and another discharge line of a pre-wet liquid need to be located individually, and furthermore a separate collection system of waste liquid will be required. Thus, to solve the existing two problems due to size reduction of pattern dimensions, a further problem exists in that construction or the control of the processing apparatus comes to be complicated.

### SUMMARY OF THE INVENTION

The present invention was made in view of the state of art as described above, and has an object of providing a processing method of substrate by which it is possible to improve wettability on the surface of the resist film with respect to a developer without adverse effect on processing size of a resist pattern, or without damage on a resist film; and by which it is also unnecessary to make separate collection of waste liquid. The invention has another object of providing a processing apparatus of a substrate capable of carrying out such method preferably. The invention has a further object of providing a processing method of a substrate by which it is possible to solve both a problem of resist pattern destruction accompanied by size reduction of pattern dimensions and a problem in water repellency of a resist that arises in relation to technical progress for size reduction of pattern dimensions; as well as an apparatus construction and control never comes to be complicated. The invention has a yet further object of providing a processing apparatus of a substrate capable of carrying out such method preferably.

The invention according to claim 1 is a processing method of a substrate comprising the steps of: prewetting in which a pre-wet liquid is discharged onto a resist film having been exposed that is formed on the surface of a substrate to make prewetting of the resist film; developing in which a developer is discharged on the resist film having been prewetted to make development of the resist film; and rinsing in which a rinse is discharged onto the resist film having been developed to make rinsing of the resist film. In the mentioned prewetting process, a solution containing a surface-active agent is fed onto the resist film having been exposed that is formed on the surface of the substrate, and thereafter pure water is further fed onto the mentioned resist film on which the solution containing a surface-active agent has been fed.

The invention according to claim 2 is a processing apparatus of a substrate comprising: substrate holding means for holding a substrate in a horizontal posture; developer feed means for feeding a developer onto a resist film having been exposed that is formed on the surface of the substrate held by the mentioned substrate holding means; and rinse feed means for feeding a rinse onto the resist film having been developed that is formed on the surface of the substrate. This processing apparatus of a substrate further comprises: solution feed means for feeding a solution containing a surface-active agent onto the resist film that is formed on the surface of the substrate; and pure water feed means for feeding pure water on the resist film that is formed on the surface of the substrate. In this processing apparatus of a substrate, before a developer is fed onto mentioned resist film on the surface of the substrate by the mentioned developer feed means, a solution containing a surface-active agent is fed onto the mentioned resist film formed on the surface of the substrate by the mentioned solution feed means, and thereafter pure water is further fed onto the mentioned resist film on the surface of the substrate by the mentioned pure water feed means.

The invention according to claim 3 is the processing apparatus as set forth in claim 2, and in which the mentioned rinse feed means feeds water as the rinse onto the resist film having been developed that is formed on the surface of the substrate; and the mentioned rinse feed means is used also as the mentioned pure water feed means.

The invention according to claim 4 is the processing apparatus as set forth in claim 2 or 3, further comprising substrate rotation means for causing a substrate held by the mentioned substrate holding means to rotate.

The invention according to claim 5 is a processing method of a substrate comprising the steps of: prewetting in which a pre-wet liquid is discharged onto a resist film having been exposed that is formed on the surface of a substrate to make prewetting of the resist film; developing in which a developer is discharged on the resist film having been prewetted to make development of the resist film; and rinsing in which a rinse is discharged onto the resist film having been developed to make rinsing of the resist film. In the mentioned prewetting process, a solution containing a surface-active agent is used as the mentioned rinse; and the same solution as the mentioned rinse containing a surface-active agent is used as the mentioned pre-wet liquid.

The invention according to claim 6 is a processing apparatus of a substrate comprising: substrate holding means for holding a substrate in a horizontal posture; developer feed means for feeding a developer onto a resist film having been exposed that is formed on the surface of the substrate held by the mentioned substrate holding means; and rinse feed means for feeding a rinse onto the resist film having been developed that is formed on the surface of the substrate. In this processing apparatus of a substrate, the mentioned rinse feed means feeds a solution containing a surface-active agent as a rinse onto a resist film having been developed that is formed on the surface of the substrate; and the mentioned rinse feed means is used also for feeding a pre-wet liquid onto the resist film before being developed that is formed on the surface of the substrate to make prewetting of the resist film; and the same solution as the mentioned rinse containing a surface-active agent is fed as a pre-wet liquid onto the resist film before being developed by the mentioned rinse feed means.

In the processing method according to claim 1 of the invention, even if a resist film has a high water repellency, since a solution containing a surface-active agent is fed onto a resist film before a developer is fed onto the resist film, wettability on the surface of the resist film with respect to pure water or the developer is improved. As a result, prewetting using pure water can be made, and by such prewetting, it is possible to cover uniformly the surface of the resist film with pure water, and to reduce the consumption of pure water. Furthermore, it is possible to form a developer film of uniform thickness on the resist film of the substrate surface when the developer is fed onto the resist film after prewetting, and to reduce the consumption of a developer as well. Further, any hydrophilizing treatment such as TMAH, IPA, and diethylethanolamine is not used, so that there is no problem of adverse effects on processing size of resist pattern, or of damage on the resist film. Besides, the apparatus construction never becomes complicated.

Since the pure water is further fed onto the resist film on which the solution containing a surface-active agent has been fed to make prewetting, the solution containing a surface-active agent is washed out with the pure water from the resist film. Thus, e.g., fluorine-based or silicon-based components of the surface-active agent remaining not dissolved in the developer are removed from the resist film, so that there is no problem of occurrence of any defect at the resist film.

When using the processing apparatus according to claim 2 of the invention, the processing method according to claim 1 of the invention can be preferably carried out, thus enabling to obtain the mentioned advantages.

In the processing apparatus according to claim 3 of the invention, since rinse feed means is used also as the pure water feed means, the apparatus construction is simplified.

In the processing apparatus according to claim 4 of the invention, since the substrate that is held by the substrate holding means is brought in rotation by the substrate rotation means after the solution containing a surface-active agent has been fed onto the resist film that is formed on the surface of the substrate, it is possible to remove an excess surfactant solution from the resist film by centrifugal force. Furthermore, since the substrate that is held by the substrate holding means is brought in rotation by the substrate rotation means after the pure water has been fed onto the resist film, it is possible to remove excess pure water from the resist film by centrifugal force. Accordingly, it is possible to form a film of surfactant solution or a film of pure water of a desired thickness on the resist film, thus enabling a uniform processing.

In the processing method according to claim 5 of the invention, since the same solution is used as a rinse and a pre-wet liquid, just providing one discharge system is sufficient for discharging respectively a rinse and a pre-wet liquid on the resist film of the substrate surface, and further no separate collection of waste liquid is needed. Furthermore, just selecting any optimum concentration of the rinse and the pre-wet liquid is sufficient, for example, with respect to a rinse, so that it is possible to reduce the number of processes for setting the required conditions. Further, owing to the use of the solution containing a surface-active agent as a rinse, when the substrate is dried after having been rinsed, the surface tension of the rinse, which may be a force causing destruction of a resist pattern in the process that the rinse is splashed or evaporated from the resist film to be removed, comes to be smaller as compared with that of pure water. In this manner, since the force causing destruction of resist pattern becomes smaller, the destruction of resist pattern is prevented. Further, even if the resist film has a high water repellency, since the solution containing a surface-active agent is fed onto the resist film as a pre-wet liquid before the developer is fed onto the resist film, the surface of the resist film is made hydrophilic, resulting in improved wettability on the surface of the resist film with respect to the developer. Therefore, when the developer is fed onto the resist film after prewetting, it is possible to form a developer film of uniform thickness on the resist film of the substrate surface, and to reduce the consumption of the developer as well.

As a result, by the processing method of the invention according to claim 5, it is possible to solve both a problem of resist pattern destruction accompanied by size reduction of pattern dimensions and a problem in water repellency of a resist that arises in relation to technical progress for size reduction of pattern dimensions. In addition, it is possible to achieve simplified apparatus construction and control.

When using the processing apparatus according to claim 6 of the invention, it is possible to preferably carry out the processing method according to claim 5 of the invention, and thus to obtain the mentioned advantages.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view showing one example of construction of a processing apparatus for use in carrying out a processing method of a substrate according to claim 1 of the present invention.

FIG. 2 is a cross sectional view of FIG. 1 taken along the line II-II indicated by arrows.

FIG. 3 is a cross sectional view of FIG. 1 taken along the line III-III indicated by arrows.

FIG. 4 is a schematic plan view showing one example of a processing apparatus for use in carrying out a processing method of a substrate according to claim 5 of the invention.

FIG. 5 is a cross sectional view of FIG. 4 taken along the line V-V indicated by arrows.

FIG. 6 is a schematic plan view showing another example of construction of a processing apparatus for use in carrying out the processing method of a substrate according to claim 5 of the invention.

FIG. 7 is a schematic longitudinal cross-sectional view of the processing apparatus shown in FIG. 6.

### DESCRIPTION OF THE PREFERRED EMBODIMENTS

Several preferred embodiments according to the present invention are hereinafter described referring to the drawings.

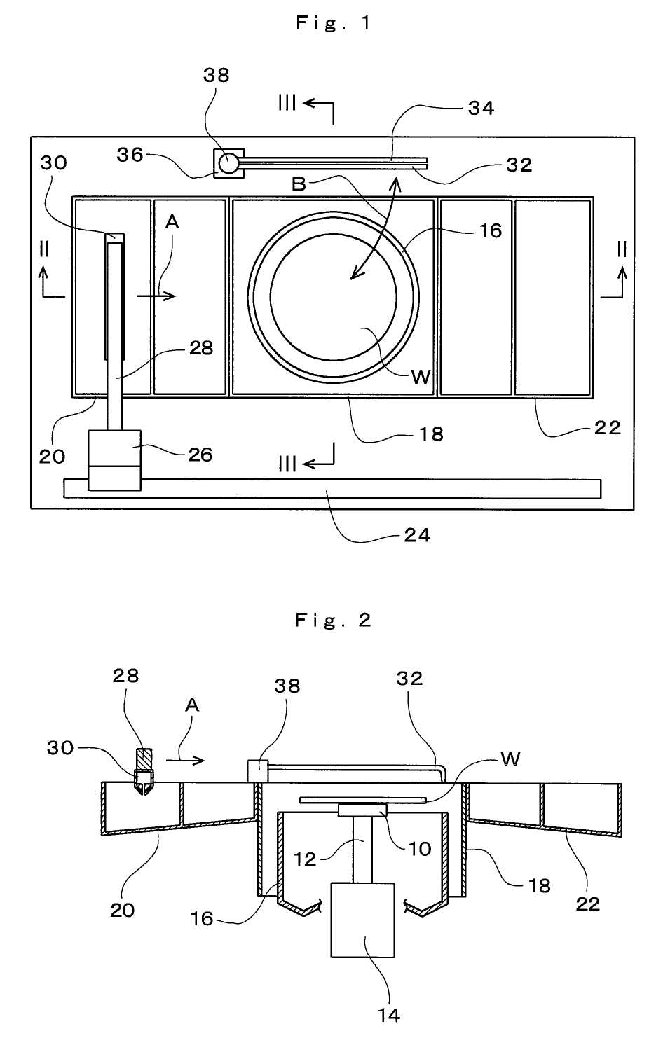

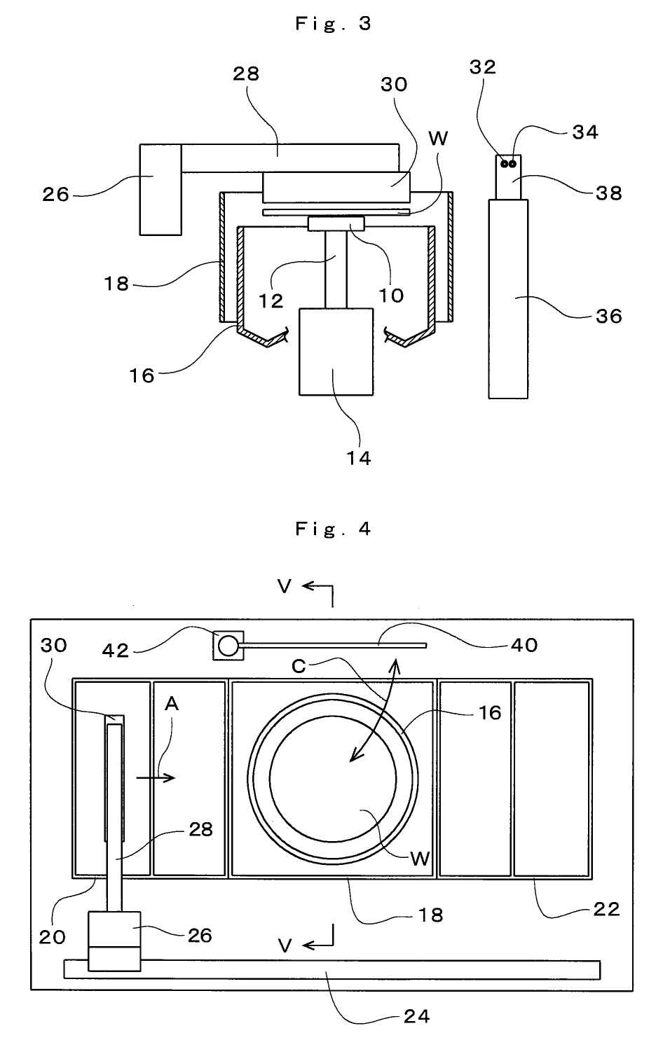

FIGS. 1 through 3 show one example of construction of a processing apparatus for use in carrying out a processing method of a substrate of the invention according to claim 1. FIG. 1 is a plan view showing the schematic construction of a processing apparatus, FIG. 2 is a cross sectional view of FIG. 1 taken along the line II-II indicated by arrows, and FIG. 3 is a cross sectional view of FIG. 1 taken along the line III-III indicated by arrows.

In this processing apparatus, at the central portion of the apparatus in which processing of a substrate W is made, there are disposed a spin chuck 10 holding the substrate W in a horizontal posture, a rotary shaft 12 to which upper end the spin chuck 10 is fixed, and which is supported vertically, and a rotation motor 14 of which rotary shaft is connected to the rotary shaft 12, and which brings the spin chuck 10 and the rotary shaft 12 in rotation about the vertical axis. Around the spin chuck 10, there is disposed a circular inside cup so as to surround the substrate W on the spin chuck 10. This inside cup 16 is supported so as to be capable of reciprocating in the vertical direction by a support mechanism, not shown. Around the inside cup 16, there is disposed a rectangular outside cup 18.

Waiting pots 20 and 22 are disposed on both right and left sides of the outside cup 18 respectively. On one side portion of the outside cup 18 and the waiting pots 20 and 22, a guide rail 24 is disposed in parallel to the connection direction of the outside cup 18 and the waiting pots 20 and 22. An arm drive part 26 is slidably engaged with the guide rail 24, and a nozzle arm 28 is held by the arm drive part 26. A developer discharge nozzle 30 is suspended in a horizontal posture from the nozzle arm 28. The developer discharge nozzle 30, although illustration of a detailed structure thereof is omitted, includes at the lower end face a slit-like outlet extending in the longitudinal direction. To the developer discharge nozzle 30, a developer feed pipe (not shown) that is connected as a flow path to a developer supply source is connected in communication. The developer discharge nozzle 30 is located in the direction orthogonal to the guide rail 24. In this manner, it is constructed such that by the arm drive part 26, the nozzle arm 28 is brought in reciprocating motion linearly in the horizontal direction along the guide rail 24, thereby making it possible that the developer discharge nozzle 30 is scanned in a direction indicated by the arrow A, and is returned in the reverse direction thereof.

Furthermore, in the vicinity on the rearward side of the outside cup 18, there are disposed a pure water discharge nozzle 32 functioning to discharge pure water from an outlet at the tip onto the substrate W, and a solution discharge nozzle 34 functioning to discharge a solution containing a surface-active agent from the outlet at the tip onto the substrate W. The pure water discharge nozzle 32 is connected to a pure water supply source through a pure water feed pipe, not shown, forming a flow path; and the solution discharge nozzle 34 is connected to a surfactant solution supply source through a solution feed pipe, not shown, forming a flow path. The pure water discharge nozzle 32 and the solution discharge nozzle 34 are held by one nozzle holding section 38 that is supported rotatably by a rotation drive part 36. In addition, it is constructed such that by turning the nozzle holding section 38 about the vertical axis by the rotation drive part 36, the purer water discharge nozzle 32 and the solution discharge nozzle 34 are turned in a horizontal plane in a direction indicated by the arrow B.

Now, one example of processing operation with the processing apparatus of above-mentioned construction is hereinafter described.

When a substrate W, on the surface of which a resist film after having been exposed is formed, is carried into the apparatus and the substrate W is held on the spin chuck 10, the solution discharge nozzle 34 (and the pure water discharge nozzle 32) are turned, the tip outlet of the solution discharge nozzle 34 moves to a position right over the center of the substrate W, and a predetermined amount of solution containing a surface-active agent having been adjusted to a predetermined concentration is dripped from the tip outlet of the solution discharge nozzle 34 and fed onto the central portion of the substrate W.

Kinds of a surface-active agent to be used herein are not particularly limited, and it is preferable to use general anionic surface-active agent or cationic surface-active agent. The surfactant solution having been fed onto the substrate W spreads all over the face of the substrate W, and covers the entire surface of the resist film of the substrate W. At this time, it is also preferable that the substrate W is in rotation at low speed. When ending the discharge of a surfactant solution, the solution discharge nozzle 34 (and the pure water discharge nozzle 32) is made to turn to return to the original position, shown in FIG. 1. When a predetermined time period has elapsed after the surfactant solution being discharged, the substrate W is brought in rotation, and thus an excess surfactant solution is made to splash away from the substrate W by centrifugal force to be removed. At this time, the inside cup 16 has been elevated.

Subsequently, the pure water discharge nozzle 32 (and the solution discharge nozzle 34) is turned, the tip outlet of the pure water discharge nozzle 32 is made to move to the position right over the center of a substrate W, and a predetermined amount of pure water is fed from the tip outlet of the pure water discharge nozzle 32 to the central portion of the substrate W. The pure water having been fed onto the substrate W spreads all over the face of the substrate W to wash out the surfactant solution from the resist film, and the surfactant solution with which the surface of the resist film has been covered is substituted with pure water. At this time, it is preferable that the substrate W is in rotation at low speed. When a predetermined time period has elapsed after the pure water being discharged, the substrate W is brought in rotation to cause the pure water to splash away from the substrate W by the centrifugal force to be removed. At this time, the inside cup 16 has been elevated. In this manner, pre-wet treatment of a resist film is made. When the discharge of pure water ends, the pure water nozzle 32 (and the solution discharge nozzle 34) is turned to return to the original position as shown in FIG. 1.

Next, while a developer is discharged from the slit-like outlet of the developer discharge nozzle 30, the developer discharge nozzle 30 is scanned in the direction indicated by an arrow A by the arm drive part 26. Thus, the developer is fed onto the substrate W to be heaped. When the developer discharge nozzle 30 is moved to a position of the right-hand waiting pot 22, the discharge of the developer is stopped, the developer discharge nozzle 30 is made to move in a direction opposite to the direction indicated by the arrow A by the arm drive part 26, and the developer discharge nozzle 30 is returned to a position of the original left-hand waiting pot 20. The substrate W is left to be stationary until a predetermined time period has elapsed after the solution being heaped on the substrate W, to develop the resist film on the surface of the substrate W.

When a predetermined time period has elapsed after the liquid being heaped on a substrate W, the pure water discharge nozzle 32 (and the solution discharge nozzle 34) is turned again, the tip outlet of the pure water nozzle 32 is made to move to the position right over the center of the substrate W, and pure water is fed to the central portion of the substrate W from the tip outlet of the pure water discharge nozzle 32. Thus, the development reaction of the resist film on the surface of the substrate W is stopped. When ending the discharge of pure water, the pure water discharge nozzle 32 (and the solution discharge nozzle 34) is made to turn to return to the original position as shown in FIG. 1 again. Then, after pure water has been discharged, the substrate W is brought in rotation to cause the pure water to splash away from the substrate W by centrifugal force to be removed, and the substrate W is dried. At this time, the inside cup 16 has been elevated. When ending the drying of the substrate W, the substrate W is removed from the spin chuck 10, and carried out of the apparatus.

In the processing method of the invention, as described above, a solution containing a surface-active agent is fed onto a resist film before a developer is fed onto the resist film having been formed on the surface of the substrate W. Therefore, even if a resist film has high water repellency, the surface of such resist film is covered with a film of surfactant solution, resulting in high wettability on the surface of the resist film with respect to the pure water and developer. Accordingly, prewetting with pure water to be made in the subsequent step comes to be possible. By the prewetting, it is possible to cover uniformly the surface of the resist film with pure water, and thus to reduce the consumption of pure water. Furthermore, when a developer is fed onto the resist film after prewetting with pure water, it is possible to form a developer film of uniform thickness on the resist film of the substrate surface, and further to reduce the consumption of developer. Further, after the surfactant solution has been fed onto the resist film on the surface of a substrate W, pure water is fed onto the resist film to make prewetting before the developer is fed onto the resist film, so that the surfactant solution is washed out with pure water from the resist film. As a result, for example, fluorine-based or silicon-based components in a surfactant solution, which are not dissolved in a developer, are removed from the resist film, so that there will be no worry of the occurrence of any defect of the resist film.

In the above-described embodiment, the slit scan method is described in which the developer discharge nozzle 30 is scanned while a developer is discharged from a slit-like outlet of the developer discharge nozzle 30 to heap a developer on the resist film of the substrate surface. However, the processing method is not particularly limited, this invention can be widely applied to any other development method in which a developer is fed onto the surface central portion of a substrate from a straight nozzle, and the substrate is brought in rotation to spread the developer all over the surface of the substrate, or the development method in which a developer is injected onto the resist film of the substrate surface from a spray nozzle with the substrate in rotation. Furthermore, in the above-described embodiment, a solution containing a surface-active agent or pure water for prewetting is fed onto the resist film of the substrate surface from a straight nozzle. However, discharge manner of surfactant solution or pure water is not particularly limited, and it is preferable to discharge a surfactant solution or pure water onto the resist film from a nozzle including a slit-like outlet or a spray nozzle. Additionally, the consumption of a surfactant solution or pure water (pre-wet liquid), the amount thereof to remain on the resist film, and the like are not particularly limited.

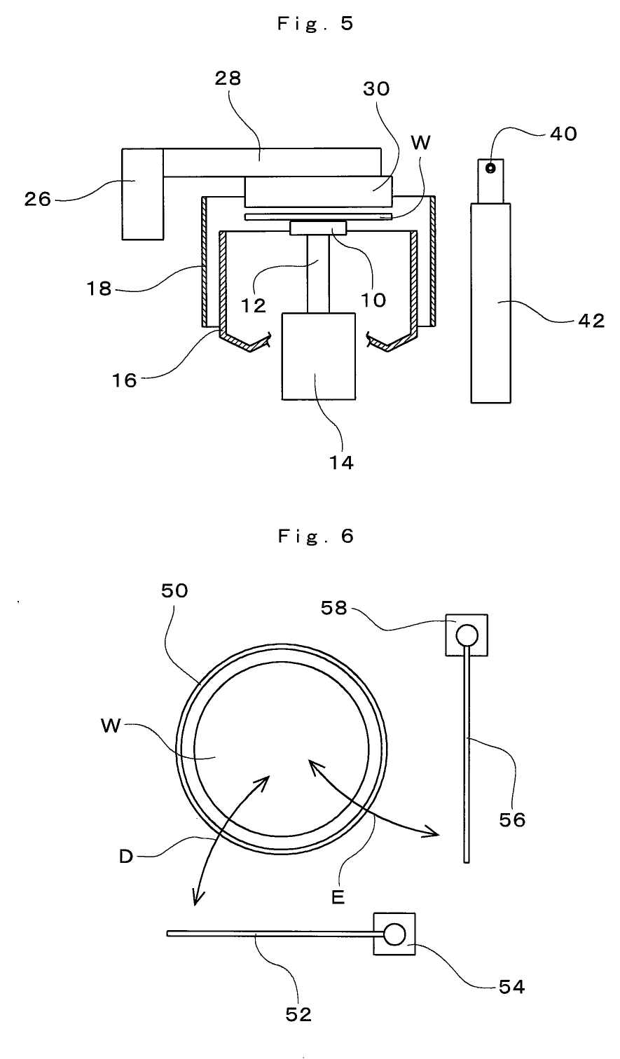

Now, FIGS. 4 and 5 show one example of construction of a processing apparatus for use in carrying out the processing method of a substrate according to claim 5 of the invention. FIG. 4 is a plan view showing a schematic construction of the processing apparatus, and FIG. 5 is a cross sectional view taken along the line V-V indicated by the arrows of FIG. 4. In the processing apparatus shown in FIGS. 4 and 5, the same reference numerals are designated to the same members as those in FIGS. 1 and 3 including the same functions and the operations, so that further descriptions thereof are omitted herein.

In this processing apparatus, there is disposed in the vicinity on the rearward side of the outside cup 18 a liquid discharge nozzle 40 functioning to discharge liquid from an outlet at the tip onto a substrate W. The liquid discharge nozzle 40 is connected to a liquid supply source through a liquid feed pipe, not shown, forming a flow path. The liquid discharge nozzle 40 is held by a nozzle holding section 42 so as to be capable of turning within a horizontal plane in a direction indicated by the arrow C thereby forming a reciprocating construction between the standby position as shown in FIG. 4 and the discharge position where an outlet at the tip is placed right over the center of the substrate W. To this liquid discharge nozzle 40, a solution containing a surface-active agent is fed, and the solution containing a surface-active agent is discharged onto the central portion of the substrate W from the tip outlet of the liquid discharge nozzle 40. Kinds of a surface-active agent to be used herein are not particularly limited, and it is preferable to use general anionic surface-active agent or cationic surface-active agent. This surface-active agent is dissolved in pure water to prepare a predetermined concentration of an aqueous solution, and is stored in the liquid supply source. This solution containing a surface-active agent is used as both a rinse and a pre-wet liquid.

One example of processing operation using the processing apparatus of above-mentioned construction is hereinafter described.

When a substrate W, on the surface of which a resist film after having been exposed is formed, is carried into the apparatus and the substrate W is held on the spin chuck 10, the liquid discharge nozzle 40 is turned, the tip outlet of the liquid discharge nozzle 40 is moved to a position right over the center of the substrate W, and a predetermined amount of solution containing a surface-active agent (pre-wet liquid) is dripped from the tip outlet of the liquid discharge nozzle 40 and fed to the central portion of the substrate W. The surfactant solution having been fed onto the substrate W spreads all over the face of the substrate W, and covers the entire surface of the resist film on the substrate W. At this time, it is preferable that the substrate W is in rotation at low speed. When ending the discharge of a surfactant solution, the liquid discharge nozzle 40 is tuned to return to the original position as shown in FIG. 4. When a predetermined time period has elapsed after the surfactant solution being discharged, the substrate W is brought in rotation to cause an excess surfactant solution to splash away from the substrate W to be removed. At this time, the inside cup 16 has been elevated. In this manner, pre-wet treatment of a resist film is made. In this manner, prewetting of a resist film is made.

Subsequently, while a developer is discharged from a slit-like outlet of the developer discharge nozzle 30, the developer discharge nozzle 30 is scanned in a direction indicated by the arrow A by the arm drive part 26. Thus, the developer is fed onto a substrate W to be heaped. When the developer discharge nozzle 30 is moved to a position of the right-hand waiting pot 22, the discharge of a developer is stopped, the developer discharge nozzle 30 is made to move in a direction opposite to the direction indicated by the arrow A by the arm drive part 26, and the developer discharge nozzle 30 is returned to a position of the original left-hand waiting pot 20. The substrate W is left stationary until a predetermined time period has elapsed after the solution being heaped on the substrate W, to develop the resist film on the surface of the substrate W.

When a predetermined time period has elapsed after the liquid being heaped on the substrate W, the liquid discharge nozzle 40 is turned again, the tip outlet of the liquid discharge nozzle 40 is made to move to a position right over the center of the substrate W, and the solution containing a surface-active agent is fed to the central portion of the substrate W from the tip outlet of the liquid discharge nozzle 40. Thus, development reaction of the resist film on the surface of the substrate W is stopped. When ending the discharge of a surfactant solution ends, the liquid discharge nozzle 40 is turned to return to the original position as shown in FIG. 4 again. Then, after the surfactant solution has been discharged, the substrate W is brought in rotation, the surfactant solution is splashed away from the substrate W by the centrifugal force to be removed, and the substrate W is dried. At this time, the inside cup 16 has been elevated. When ending the drying of the substrate W, the substrate W is removed from the spin chuck 10, and carried out of the apparatus.

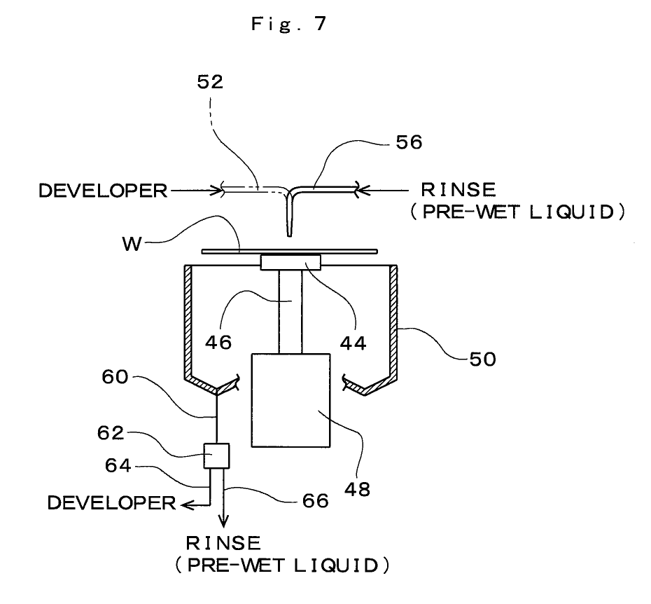

Now, FIGS. 6 and 7 show another example of construction of a processing apparatus for use in carrying out the processing method of a substrate according to claim 5 of the invention. FIG. 6 is a plan view showing the schematic construction of the processing apparatus, and FIG. 7 is a schematic longitudinal cross-sectional view thereof.

In this processing apparatus, at the central portion of an apparatus in which processing of a substrate W is made, there are disposed a spin chuck 44 holding a substrate W in a horizontal posture, a rotary shaft 46 to which upper end the spin chuck 44 is fixed and, which is supported vertically, and a rotation motor 48 of which rotary shaft is connected to the rotary shaft 46, and which brings the spin chuck 44 and the rotary shaft 46 in rotation about the vertical axis. There is further disposed around the spin chuck 44 a circular inside cup 50 so as to surround the substrate W on the spin chuck 44. The cup 50 is supported so as to be capable of reciprocating in the vertical direction by the support mechanism, not shown.

In the vicinity on the front side of the cup 50, there is disposed a developer discharge nozzle 52 functioning to discharge a developer onto the substrate W from an outlet at the tip. The developer discharge nozzle 52 is connected to a developer supply source through a developer feed pipe, not shown, forming a flow path. This developer discharge nozzle 52 is held by a nozzle holding section 54 so as to be capable of turning within a horizontal plane in a direction indicated by the arrow D, and is formed into a construction of reciprocating between a waiting position as shown in FIG. 6, and a discharge position where an outlet at the tip is placed right over the center of the substrate W.

Furthermore, in the vicinity on the lateral side of the cup 50, there is disposed a liquid discharge nozzle 56 functioning to discharge liquid onto the substrate W from the outlet at the tip. The liquid discharge nozzle 56 is connected to a liquid supply source through a liquid feed pipe, not shown, forming a flow path. The liquid discharge nozzle 56 is held by a nozzle holding section 58 so as to be capable of turning within a horizontal plane in a direction indicated by the arrow E, and is formed into a construction of reciprocating between a waiting position as shown in FIG. 6, and a discharge position where an outlet at the tip is located right over the center of the substrate W. To this liquid discharge nozzle 56, a solution containing a surface-active agent is fed. Further, the solution containing a surface-active agent having been adjusted to a predetermined concentration is discharged onto the central portion of the substrate W from the tip outlet of the liquid discharge nozzle 56. This solution containing a surface-active agent is used as both a rinse and a pre-wet liquid.

Further, a drain 60 is connected in communication to the bottom of the cup 50. The drain 60 is connected to an inflow side connection of a flow path-switching valve 62. Although the detailed internal structure of the flow path-switching valve 62 is not illustrated, it is in such construction that an inflow side connecting port is brought in communication with any one of two-outflow side connecting ports by switching of the internal flow paths. Further, a developer collection pipe 64 is connected to one of the outflow connections, and a rinse and pre-wet liquid collection pipe 66 is connected to the other outflow side connection. Owing to such construction, a developer and a rinse and pre-wet liquid can be separately collected.

Now, one example of processing operation with the processing apparatus shown in FIGS. 6 and 7 is hereinafter described.

When the substrate W, on which surface a resist film having been exposed, is carried in the processing apparatus, and the substrate W is held on the spin chuck 44, the liquid discharge nozzle 56 is turned, the tip outlet of the liquid discharge nozzle 56 is moved to a position right over the center of the substrate W, and a solution containing a surface-active agent (pre-wet liquid) is fed from the tip outlet of the liquid discharge nozzle 56 to the central portion of the substrate W. The surfactant solution having been fed onto the substrate W spreads all over the face of the substrate W, and covers the entire surface of a resist film. At this time, it is preferable that the substrate W is in rotation at low speed. When a predetermined time period has elapsed after the surfactant solution being discharged, the substrate W is brought in rotation to cause an excess surfactant solution to splash away from the substrate W to be removed. At this time, the cup 50 has been elevated. Thus, prewetting of the resist film is made. When ending the discharge of a surfactant solution, the liquid discharge nozzle 56 is turned to return to the original position as shown in FIG. 6.

Subsequently, the developer discharge nozzle 52 is turned, whereby the tip outlet of the developer discharge nozzle 52 is made to move to the position right over the center of a substrate W. Further, while the substrate W is in rotation at low speed, a predetermined amount of developer is dripped onto the central portion of the substrate W from the tip outlet of the developer discharge nozzle 52. The developer having been fed on the substrate W spreads all over the face of the substrate W to be applied onto the resist film so as to cover the entire surface of the resist film. When ending the application of a developer, the developer discharge nozzle 52 is turned to return to the original position as shown in FIG. 6.

When a predetermined time period has elapsed after a developer being applied onto to substrate W, the liquid discharge nozzle 56 is turned again, the tip outlet of the liquid discharge nozzle 56 is made to move to the position right over the center of the substrate W, and a solution containing a surface-active agent (rinse) is fed from the tip outlet of the liquid discharge nozzle 56 to the central portion of the substrate W. Thus, development reaction of the resist film on the surface of the substrate W is stopped. When ending the discharge of a surfactant solution, the liquid discharge nozzle 56 is turned to return to the original position as shown in FIG. 4. Then, after the surfactant solution has been discharged, the substrate W is brought in rotation, the surfactant solution is splashed away from the substrate W by the centrifugal force to be removed, and the substrate W is dried. At this time, the cup 50 has been elevated. When ending the drying of the substrate W, the substrate W is removed from the spin chuck 44 to carry out of the apparatus.

In the processing method according to the invention, as described above, since a solution containing a surface-active agent is used as a rinse, when a substrate is dried after having been rinsed, a surface tension of the rinse coming to be a force that may cause destruction phenomenon of resist pattern in the drying process becomes small as compared with that of pure water. Accordingly, the destruction of resist pattern is prevented. Furthermore, even if a resist film has a high water repellency, since the solution containing a surface-active agent is fed onto a resist film as a pre-wet liquid, the surface of the resist film is made hydrophilic, resulting in high wettability on the surface of the resist film with respect to the developer. Therefore, when the developer is fed onto a resist film after prewetting, it is possible to form a developer film of uniform thickness on the resist film of the substrate surface, and further to reduce consumption of the developer. Further, since the same solution containing a surface-active agent is used as a rinse and a pre-wet liquid, just one liquid discharge nozzle 56 is sufficient for discharging respectively the rinse and pre-wet liquid on the resist film of the substrate surface. In addition, it becomes unnecessary to make separate collection of each of waste liquid of the rinse and the pre-wet liquid. Furthermore, just selecting any optimum concentration of the rinse and the pre-wet liquid is sufficient, for example, with respect to a rinse, so that it is possible to reduce the number of processes for setting the required conditions.

In the above-mentioned embodiment, described is the slit scan method in which the developer discharge nozzle 30 is scanned while a developer is discharged from a slit-like outlet of the developer discharge nozzle 30 to heap a developer on a resist film of the substrate surface, or the development method in which a developer is fed from the developer discharge nozzle 52 (straight nozzle) onto the central portion of a surface of a substrate, and the substrate is brought in rotation to spread the developer all over the surface of the substrate. However, processing methods are not limited to the foregoing methods. The invention may be widely applied also to the development method in which a developer is injected from a spray nozzle onto a resist film of the substrate surface while the substrate is in rotation. Furthermore, discharge mode of the solution containing a surface-active agent (rinse and a pre-wet liquid) is not limited as well.

What is claimed is:

1. A processing method of a substrate comprising the steps of:
prewetting in which a pre-wet liquid is discharged onto a resist film having been exposed that is formed on the surface of a substrate to make prewetting of the resist film;
developing in which a developer is discharged on the resist film having been prewetted to make development of the resist film; and
rinsing in which a rinse is discharged onto the resist film having been developed to make rinsing of the resist film;
wherein in said prewetting process, a solution containing a surface-active agent is fed onto the resist film having been exposed that is formed on the surface of the substrate, and thereafter pure water is further fed onto said resist film on which the solution containing a surface-active agent has been fed.

2. A processing apparatus of a substrate comprising:
substrate holding means for holding a substrate in a horizontal posture;
developer feed means for feeding a developer onto a resist film having been exposed that is formed on the surface of a substrate held by said substrate holding means; and
rinse feed means for feeding a rinse onto a resist film having been developed that is formed on the surface of the substrate;
the processing apparatus of a substrate further comprising:
solution feed means for feeding a solution containing a surface-active agent onto the resist film that is formed on the surface of the substrate; and
pure water feed means for feeding pure water on the resist film that is formed on the surface of the substrate;
wherein before a developer is fed onto said resist film on the surface of the substrate by said developer feed means, a solution containing a surface-active agent is fed onto said resist film formed on the surface of the substrate by said solution feed means, and thereafter pure water is further fed onto said resist film on the surface of the substrate by said pure water feed means.

3. The processing apparatus of a substrate according to claim 2, wherein said rinse feed means feeds water as a rinse onto a resist film having been processed that is formed on the surface of the substrate; and
said rinse feed means is used also as said pure water feed means.

4. The processing apparatus of a substrate according to claim 2 or 3, further comprising substrate rotation means for causing a substrate held by said substrate holding means to rotate.

5. A processing method of a substrate comprising the steps of:
prewetting in which a pre-wet liquid is discharged onto a resist film having been exposed that is formed on the surface of a substrate to make prewetting of the resist film;
developing in which a developer is discharged on the resist film having been prewetted to make development of the resist film; and
rinsing in which a rinse is discharged onto the resist film having been developed to make rinsing of the resist film;
wherein a solution containing a surface-active agent is used as said rinse; and
the same solution as said rinse containing a surface-active agent is used as said pre-wet liquid.

6. A processing apparatus of a substrate comprising:
substrate holding means for holding a substrate in a horizontal posture;
developer feed means for feeding a developer onto a resist film having been exposed that is formed on the surface of a substrate held by said substrate holding means; and
rinse feed means for feeding a rinse onto a resist film having been processed that is formed on the surface of the substrate;
wherein said rinse feed means feeds a solution containing a surface-active agent as a rinse onto the resist film having been processed that is formed on the surface of the substrate; and
said rinse feed means is used also for feeding a pre-wet liquid onto the resist film before being developed that is formed on the surface of the substrate to make prewetting of the resist film; and the same solution as said rinse containing a surface-active agent is fed as a pre-wet liquid onto the resist film before being processed by said rinse feed means.
